(19) United States
(12) Patent Application Publication
(10) Pub. No.: US 2006/0224786 A1
(43) Pub. Date: Oct. 5, 2006

(54) Signal transfer apparatus and signal transfer method

(75) Inventors: Takanobu Mukaide, Tachikawa-shi (JP); Yuusuke Nosaka, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/376,275

(22) Filed: Mar. 16, 2006

(30) Foreign Application Priority Data
Mar. 31, 2005 (JP) 2005-100293

(51) Int. Cl. G06F 3/00

(52) U.S. Cl. 710/48

(57) ABSTRACT

According to one embodiment, descriptors with respective identifiers are created for a video stream and time information including its transfer start time, and the descriptors, time information, and video stream are recorded in a storage unit. In the case where a descriptor that indicates time information is read when the descriptors are successively read from the storage unit and the video stream is transferred from the storage unit to a transfer subject, transfer of the video stream is controlled on the basis of the time information.

### CROSS-REFERENCE TO RELATED APPLICATIONS

This application is based upon and claims the benefit of priority from Japanese Patent Application No. 2005-100293, filed Mar. 31, 2005, the entire contents of which are incorporated herein by reference.

### BACKGROUND

1. Field

One embodiment of the present invention relates to a signal transfer apparatus and signal transfer method which transfers signals such as video and audio by direct memory access (DMA).

2. Description of the Related Art

As is generally known, for example, when video, audio and the like are transferred by DMA via a general-purpose bus such as a peripheral component interconnect (PCI) bus, it becomes impossible to start signal transfer steadily with constant timing even if time control is made to instruct to start signal transfer because signal transfer start timing or the like is varied due to congestion of the bus.

Jpn. Pat. Appln. KOKAI Publication No. 6-149715 discloses a configuration of system bus connection apparatus in which, in the case where a descriptor read from a memory device is a termination descriptor and reception is determined to be continued when transmission and reception operation is controlled via a system bus of a message of an arbitrary length by the descriptor, transmission interruption is requested to a transmission source.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 shows one embodiment of the present invention and is a block configuration diagram shown to explain the outline of an optical disk reproducing apparatus;

FIG. 2 is a drawing shown to explain the relationship among time information, video stream, and descriptor in the same embodiment;

FIG. 3 is a block configuration diagram shown to explain detail of a video memory unit and a DMA transfer unit of the optical disk reproducing apparatus in the same embodiment;

FIG. 4 is a flow chart shown to explain main processing operation of the DMA transfer unit in the same embodiment; and

FIG. 5 is a block configuration diagram shown to explain a modified example of the optical disk reproducing apparatus in the same embodiment.

### DETAILED DESCRIPTION

Various embodiments according to the invention will be described hereinafter with reference to the accompanying drawings. In general, according to one embodiment of the invention, descriptors with respective identifiers are created for a video stream and time information including its transfer start time, and the descriptors, time information, and video stream are recorded in a storage unit. In the case where a descriptor that indicates time information is read when the descriptors are successively read from the storage unit and the video stream is transferred from the storage unit to a transfer subject, transfer of the video stream is controlled on the basis of the time information.

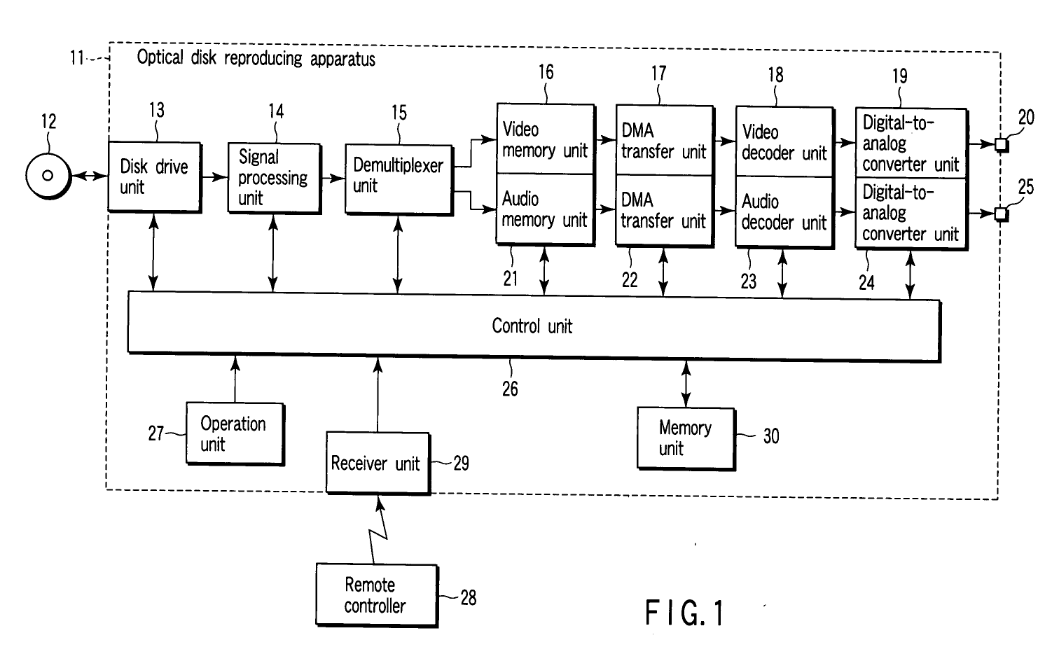

FIG. 1 shows the outline of an optical disk reproducing apparatus 11 to be explained in this embodiment. The optical disk reproducing apparatus 11 has a disk drive unit 13 to/from which an optical disk 12 such as a digital versatile disk (DVD) can be attached/detached.

The disk drive unit 13 reads a recorded information stream from the mounted optical disk 12. The information stream read by the disk drive unit 13 is supplied to a demultiplexer unit 15 after being provided with a predetermined digital signal processing by a signal processing unit 14 and is separated into a video stream and an audio stream.

Of these, the video stream is accumulated in a video memory unit 16. The video stream accumulated in this video memory unit 16 is transferred from the DMA transfer unit 17 to a video decoder unit 18 and is decoded. The, it is converted into analog video signals by a digital-to-analog converter unit 19 and is taken out from an output terminal 20.

In addition, the audio stream separated by the demultiplexer unit 15 is accumulated in an audio memory unit 21. The audio stream accumulated in the audio memory unit 21 is transferred to an audio decoder unit 23 by a DMA transfer unit 22 and decoded. Then, it is converted into analog audio signals by a digital-to-analog converter unit 24 and taken out from an output terminal 25.

Now, the optical disk reproducing apparatus 11 has all the operations including the above-mentioned reproducing operation generally controlled by a control unit 26. The control unit 26 incorporates a central processing unit (CPU), etc., and receives operation information from an operation unit 27 or operation information from a remote controller 28 via a receiver unit 29, and controls each unit such that its operation content is reflected.

In this case, the control unit 26 uses a memory unit 30. The memory unit 30 primarily has a read-only memory (ROM) which stores a control program executed by the CPU, a random access memory (RAM) which provides a work area to the CPU, and a nonvolatile memory in which various kinds of setting information, control information, and the like are stored.

Now, means for transferring the video stream accumulated in the video memory unit 16 to the video decoder unit 18 by the DMA transfer unit 17 will be explained in detail. With respect to means for transferring the audio stream accumulated in the audio memory unit 21 to the audio decoder unit 23 by the DMA transfer unit 22, the description will be omitted because it is substantially same as the case of the video stream.

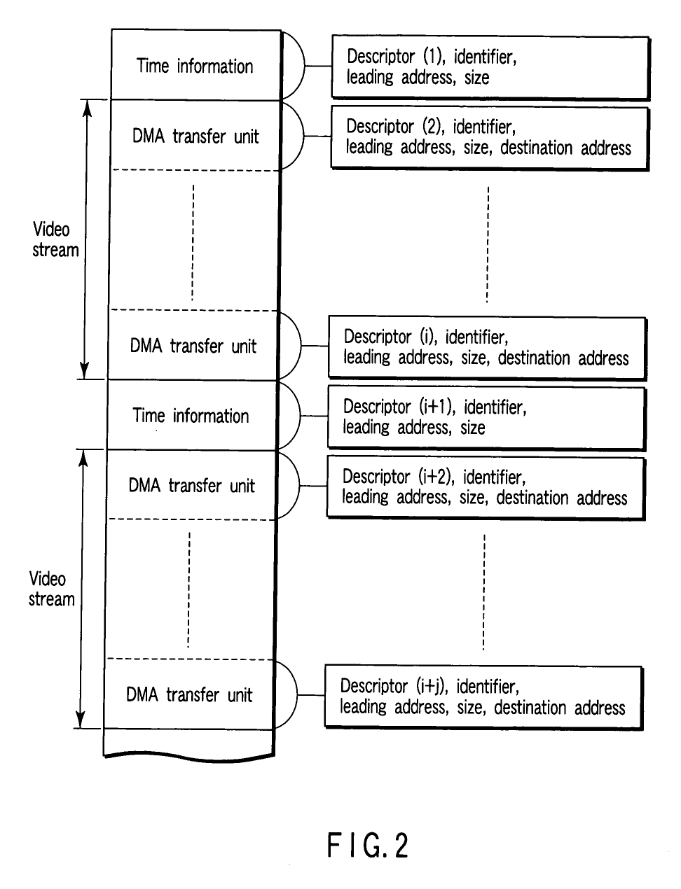

That is, the demultiplexer unit 15 separates a video stream and its attribute information from the stream (input signal) supplied by the signal processing unit 14. In this case, the demultiplexer unit 15 divides the continuing video streams into each predetermined DMA transfer unit as shown in FIG. 2, and on its way, allocates time information that shows a transfer start timing included in the attribute information, successively outputs to the video memory unit 16 to be accumulated.

In addition, the demultiplexer unit 15 generates a descriptor for time information and DMA transfer unit of a video stream. The descriptor has consecutive number 1, 2, . . . , i, i+1, i+2, . . . , i+j . . . in order of outputs irrespective of time information and video stream.

In a descriptor that corresponds to time information, an identifier that indicates that the descriptor corresponds to the time information, a leading address of the video memory unit 16 accumulated in the time information, the size of the time information, and the like are included.

Further, in a descriptor that corresponds to a DMA transfer unit of a video stream, an identifier that indicates that the descriptor corresponds to the video stream, a leading address of the video memory 16 where the video stream is accumulated, the size of the video stream, a destination address of the video stream, and the like are included.

The demultiplexer unit 15 outputs a plurality of descriptors generated as above to the video memory unit 16 and allows them to be accumulated as a descriptor table.

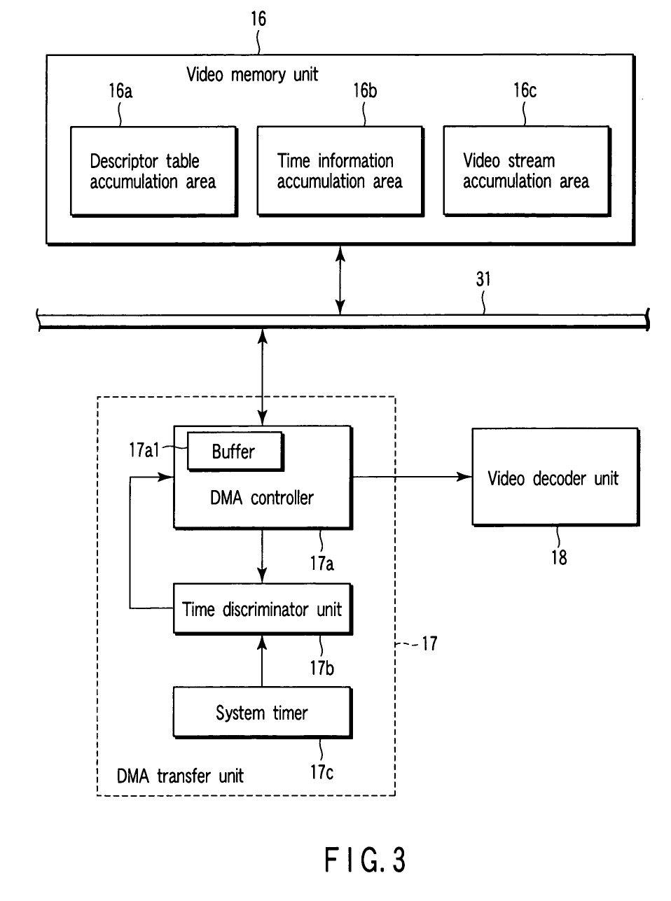

Thereby, as shown in FIG. 3, a descriptor table accumulation area 16a which accumulates descriptor tables, a time information accumulation area 16b which accumulates each item of time information, and a video stream accumulation area 16c which accumulates a video stream in DMA transfer units are formed on the video memory unit 16.

In this case, the video memory unit 16 is connected to a common bus 31 used for other data transfer. In addition, the DMA transfer unit 17 is connected to the bus 31. The DMA transfer unit 17 is equipped with a DMA controller 17a having a buffer 17a1 built therein, a time discriminator unit 17b, a system timer 17c, and the like.

The DMA controller 17a transfers a video stream via the bus 31 from the video stream accumulation area 16c of the video memory unit 16, and operates to transfer to the video decoder unit 18 which becomes a transfer subject.

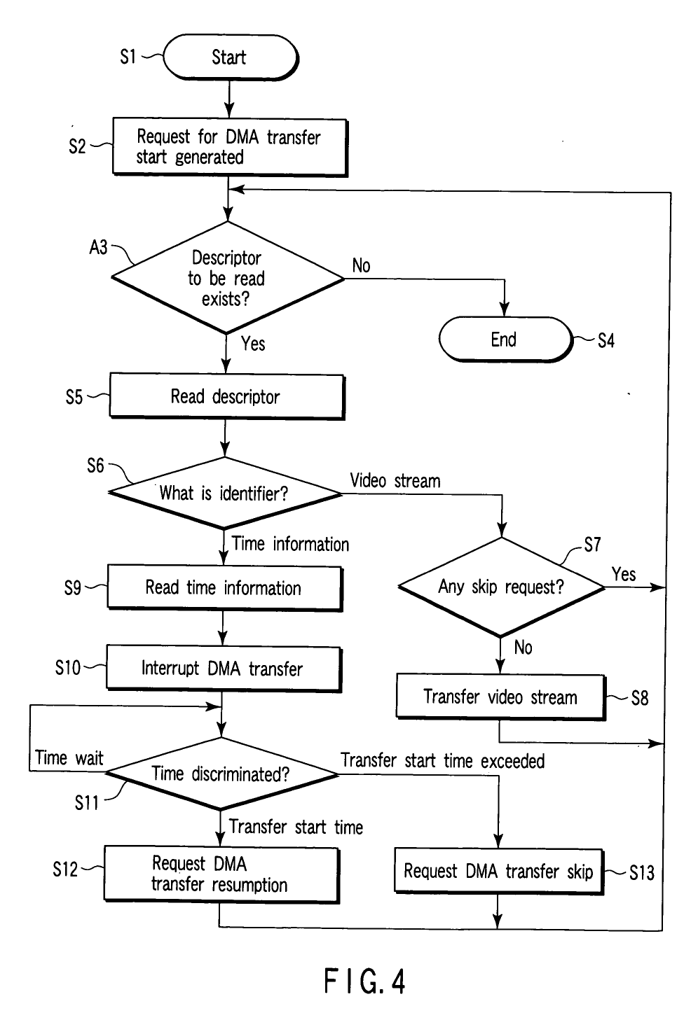

FIG. 4 shows a flow chart which summarizes DMA transfer operation in the DMA transfer unit 17. First of all, processing is started (Block S1), and when a DMA transfer start request is generated from the control unit 26 in Block S2, the DMA controller 17a accesses the descriptor table accumulation area 16a of the video memory unit 16, and discriminates whether or not any descriptor to be read exists, that is, whether or not reading of the last descriptor described in the descriptor table is finished in Block S3.

In the case where it is determined that there is no descriptor to be read in the descriptor table (NO), the DMA controller 17a finishes processing as it is (Block S4).

On the other hand, in the case where it is determined that any descriptor to be read exists in the descriptor table in the above Block S3 (YES), the DMA controller 17a reads a predetermined descriptor from the descriptor table in Block S5, and discriminates whether an identifier of the read descriptor indicates a video stream or time information in Block S6.

In the case where it is determined that the identifier indicates a video stream, the DMA controller 17 discriminates whether or not any skip request for DMA transfer is generated in Block S7. In the case where it is determined that the skip request is generated (YES), the DMA controller is returned to processing of Block 3.

In addition, in the case where in the above Block S7, it is determined that no DMA transfer skip request is generated (NO), the DMA controller 17, in Block S8, transfers the video stream to the video decoder unit 18 via the bus 31 from the video stream accumulation region 16c of the video memory unit 16 based on the leading address, size, and destination address included in the descriptor read in the Block S5 previously, and the DMA controller is returned to processing of Block S3.

On the other hand, in the case where the descriptor identifier is determined to indicate time information in the above Block S6, the DMA controller 17, in Block S9, transfers time information via the bus 31 from the time information accumulation area 16b of the video memory unit 16 based on the leading address and size included in the descriptor read in Step S5 previously, and DMA transfer operation is interrupted in Block S10.

Then, in Block S11, the DMA controller 17 allows the time discriminator unit 17b to compare the transfer start time indicated by the read time information with the current time generated by the system timer 17c. Based on the comparison result, the DMA controller 17 discriminates whether the current time has not yet reached the transfer start time, the current time has reached the transfer start time, or the current time has exceeded the transfer start time.

In the case where in Block S11, it is determined that the current time has not yet reached the transfer start time, the DMA controller 17 is kept to the time waiting state until the current time reaches the transfer start time. Then, transfer of the video stream to the video decoder unit 18 is interrupted.

In addition, in the case where in Block S11, it is determined that the current time has reached the transfer start time, the DMA controller 17 requests the resumption of DMA transfer in Block S12 and is returned to processing of Block S3. Consequently, when an identifier of a next read descriptor indicates a video stream, the video stream designated by the descriptor is read by the DMA controller 17a and transferred to the video decoder unit 18.

Furthermore, in the case where in Block S11, the current time is determined to exceed the transfer start time, the DMA controller 17 requests skip of DMA transfer in Block S13 and is returned to processing of Block S3. Consequently, until a descriptor which indicates a next time information is read, descriptors are read and discarded, and transfer of a video stream to the video decoder unit 18 is interrupted.

According to the above-mentioned embodiment, descriptors are created with identifiers added to the time information that indicates transfer start timing and to the DMA transfer unit of the video stream, respectively, and the DMA controller 17a carries out DMA transfer of the video stream based on descriptors. In such a case, when the descriptor that indicates time information is read, the transfer start time shown by the time information and the current time are compared to control DMA transfer, and therefore, it becomes possible to start DMA transfer of the video stream more accurately at the transfer start time.

Further, the DMA controller 17 may be allowed to request the resumption of DMA transfer in the time waiting state until the current time reaches the transfer start time before a predetermined time at which the current time reaches the transfer start time. The video stream read before the current time reaches the transfer start time may be recorded in the buffer 17a1, and at the time when the current time reaches the transfer start time, the video stream recorded in the buffer 17a1 may be transferred to the video decoder unit 18. This will achieve still more accurate DMA transfer.

In this case, the buffer 17a1 with larger recording capacity is desirable, but when practical use is taken into account, the buffer 17a1 should have a capacity to record the video stream that corresponds to the time before it has a priority turn using the bus 31 for DMA transfer.

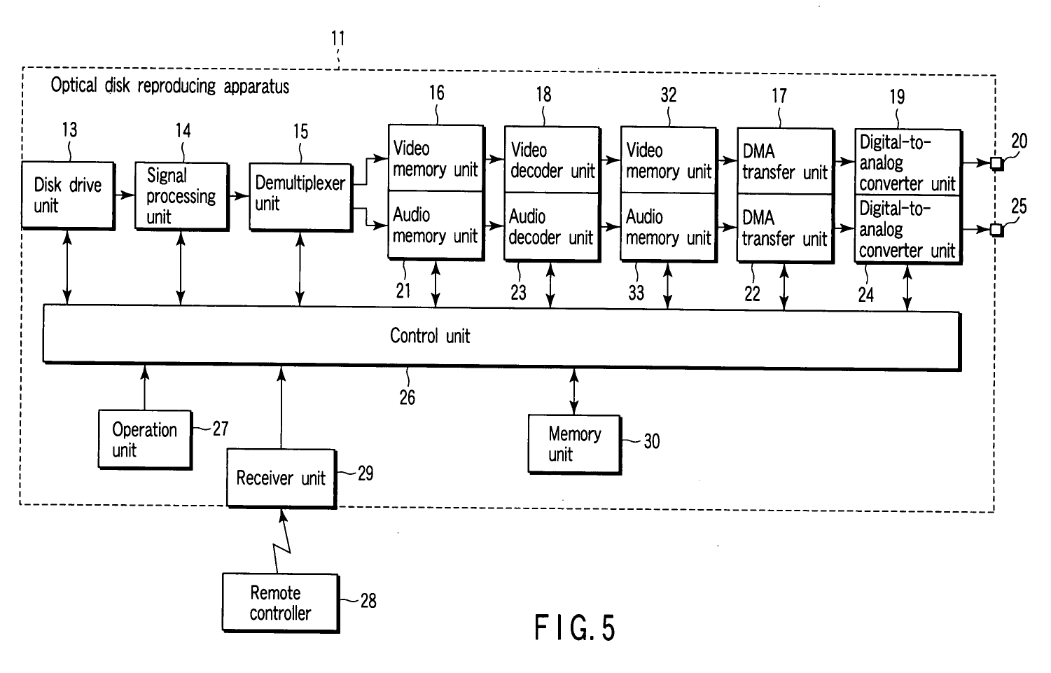

FIG. 5 shows a modified example of the above-mentioned embodiment. In FIG. 5, the like reference characters designate like or corresponding parts of FIG. 1, and the video stream accumulated in the video memory unit 16 is provided with decode processing by the video decoder unit 18 and is accumulated in the video memory unit 32. Then, the video stream accumulated in the video memory unit 32 is transferred to the digital-to-analog converter unit 19 by the DMA transfer unit 17 and is converted to analog video signals.

In addition, the audio stream accumulated in the audio memory unit 21 is provided with decode processing by the audio decoder unit 23 and is accumulated in the audio memory unit 33. Then, the audio stream accumulated in this audio memory unit 33 is transferred to the digital-to-analog converter unit 24 by the DMA transfer unit 22 and is converted into analog audio signals.

In this way, it is also possible to use DMA transfer for transfer of a video stream from the video memory unit 32 to the digital-to-analog converter unit 19, transfer of an audio stream from the audio memory unit 33 to the D/A converter unit 24, and others.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A signal transfer apparatus comprising:
a processing unit configured to separate an information stream and time information including its transfer start time from an input signal, and create descriptors with respective identifiers for the information stream and time information;
a storage unit configured to store the information stream, time information, and descriptors obtained in the processing unit;
a transfer unit configured to read a descriptor from the storage unit via a bus, and in the case where the read descriptor has an identifier that indicates an information stream, read an information stream from the storage unit via the bus and transfer the read information stream to a predetermined transfer subject; and
a transfer control unit configured to read a descriptor from the storage unit via a bus, and in the case where the read descriptor has an identifier which indicates time information, interrupt transfer of the information stream by the transfer unit, and also to read time information from the storage unit via the bus and control transfer the information stream by the transfer unit on the basis of the read time information.

2. A signal transfer apparatus according to claim 1, wherein
the transfer control unit is configured to compare the transfer start time included in the time information read from the storage unit via the bus with a current time and to control transfer of the information stream by the transfer unit on the basis of the comparison results.

3. A signal transfer apparatus according to claim 2, wherein
the transfer control unit is configured to continue interruption of transfer of the information stream by the transfer unit until the current time reaches the transfer start time in the case where the current time has not yet reached the transfer start time as a result of comparison between the transfer start time and the current time.

4. A signal transfer apparatus according to claim 2, wherein
the transfer control unit is configured to resume transfer of the information stream by the transfer unit at the time when the current time has reached the transfer start time as a result of comparison between the transfer start time and the current time.

5. A signal transfer apparatus according to clam 2, wherein
the transfer control unit is configured to read and discard descriptors having identifiers that indicate an information stream until a next descriptor having an identifier that indicates time information is read when the current time exceeds the transfer start time as a result of comparison between the transfer start time and the current time.

6. A signal transfer apparatus according to claim 2, wherein
the transfer control unit is configured to read an information stream from the storage unit before a predetermined time when the current time reaches the transfer start time in the case where the current time has not yet reached the transfer start time as a result of comparison of the transfer start time and the current time, temporarily stores the read information stream, and transfers from the temporarily stored information stream to a predetermined transfer subject at the time when the current time reaches the transfer start time.

7. A signal transfer method comprising:
a first block of separating an information stream and time information including its transfer start time from an input signal, and creating descriptors with respective identifiers for the information stream and time information;
a second block of storing the information stream, time information, and descriptors obtained in the first block;
a third block of reading a descriptor from the storage unit via a bus, and in the case where the read descriptor has an identifier that indicates an information stream, reading the information stream from the storage unit via the bus and transferring the read information stream to a predetermined transfer subject; and
a fourth block of reading a descriptor from the storage unit via a bus, and in the case where the read descriptor has an identifier that indicates time information, interrupting transfer of the information stream by the third block, reading time information from the storage unit via the bus, and controlling transfer of the information stream by the third block on the basis of the read time information.

8. A signal transfer method according to claim 7, wherein
the fourth block comprising the transfer start time included in the time information read from the storage unit via the bus with a current time and controlling transfer of the information stream by the third block on the basis of the comparison results.

9. A signal transfer method according to claim 8, wherein
the fourth block continuing interruption of transfer of the information stream by the third block until the current time reaches the transfer start time in the case where the current time has not yet reached the transfer start time as a result of comparison between the transfer start time and the current time.

10. A signal transfer apparatus according to claim 8, wherein
the fourth block resuming transfer of the information stream by the third block at the time when the current time has reached the transfer start time as a result of comparison between the transfer start time and the current time.

11. A signal transfer method according to clam 8, wherein
the fourth block reading and discarding descriptors having identifiers that indicate information streams until a next descriptor having an identifier that indicates time information is read when the current time exceeds the transfer start time as a result of comparison between the transfer start time and the current time.

12. A signal transfer method according to claim 8, wherein
the fourth block reading an information stream from the storage unit before a predetermined time when the current time reaches the transfer start time in the case where the current time has not yet reached the transfer start time as a result of comparison between the transfer start time and the current time, temporarily stores the read information stream, and transfers from the temporarily stored information stream to a predetermined transfer subject at the time when the current time reaches the transfer start time.

13. A reproducing apparatus comprising:
a reader unit configured to read signals recorded in an information recording medium from the information recording medium;
a processing unit configured to separate an information stream and time information including its transfer start time from the signals read by the reader unit and create descriptors with respective identifiers for the information stream and time information;
a storage unit configured to store the information stream, time information, and descriptors obtained in the processing unit;
a transfer unit configured to read a descriptor from the storage unit via a bus, and in the case where the read descriptor has an identifier that indicates the information stream, read the information stream from the storage unit via the bus, and transfer the read information stream to a predetermined transfer subject; and
a transfer control unit configured to read a descriptor from the storage unit via a bus, and in the case where the read descriptor has an identifier that indicates time information, interrupt transfer of the information stream by the transfer unit, and also to read time information from the storage unit via the bus, and control transfer of the information stream by the transfer unit on the basis of the read time information.
